(19) United States
(12) Patent Application Publication
(10) Pub. No.: US 2026/0013537 A1
(43) Pub. Date: Jan. 15, 2026

(54) USE OF PLANT FIBERS TO IMPROVE FLAVOR OF FERMENTED PRODUCTS

(71) Applicant: Firmenich SA, Satigny (CH)

(72) Inventors: Philipp ERNI, Satigny (CH); Amal ELABBADI, Satigny (CH); Isabelle CAYEUX, Satigny (CH); Jean-Luc GELIN, Satigny (CH)

(73) Assignee: Firmenich SA, Satigny (CH)

(21) Appl. No.: 19/140,473

(22) PCT Filed: Jan. 9, 2024
(86) PCT No.: PCT/EP2024/050390

§ 371 Date: Jun. 18, 2025

Related U.S. Application Data
(60) Provisional application No. 63/437,781, filed on Jan. 9, 2023.

(30) Foreign Application Priority Data
Jan. 10, 2023 (EP) 23150984.5

(51) Int. Cl. A23L 27/00; A23C 9/137; A23C 11/10; A23L 11/50; A23L 11/65; A23L 27/10; A23L 29/212; A23L 29/231

(52) U.S. Cl. CPC A23L 27/88; A23C 9/137; A23C 11/106; A23L 11/50; A23L 11/65; A23L 27/10; A23L 27/84; A23L 27/86; A23L 29/212; A23L 29/231

(57) ABSTRACT

The present disclosure relates generally to the use of plant fibers or starches to enhance the taste or texture of fermented dairy and dairy analogue products. In some embodiments, the dairy analogue products are vegan yogurt products formed from the fermentation of plant milks, such as soy milk, almond milk, hazelnut milk, sesame milk, pistachio milk, potato milk, banana milk, flaxseed milk, macadamia nut milk, cashew milk, oat milk, hemp milk, coconut milk, and pea-derived milks. In some embodiments, the plant fibers include pectin, inulin, fruit fiber (such as apple fiber or citrus fiber), starch, oat fiber, pea fiber, seaweed fiber, and any combinations thereof. In some embodiments, the enhancement of taste or texture includes reducing a green vegetal taste, reducing a sour taste, increasing a sweet taste, reducing a bitter taste, reducing an astringent taste, increasing firmness, reducing a grainy texture, increasing thickness, increasing mouthfeel, or any combination thereof. In certain related aspects, the disclosure provides comestible compositions that include fermented plant milk and a plant fiber or starch.

### TECHNICAL FIELD

The present disclosure relates generally to the use of plant fibers or starches to enhance the taste or texture of dairy analogue products. In some embodiments, the dairy analogue products are vegan yogurt products formed from the fermentation of plant milks, such as soy milk, almond milk, hazelnut milk, sesame milk, pistachio milk, potato milk, banana milk, flaxseed milk, macadamia nut milk, cashew milk, oat milk, hemp milk, coconut milk, and pea-derived milks. In some embodiments, the plant fibers include pectin, inulin, fruit fiber (such as apple fiber or citrus fiber), starch, oat fiber, pea fiber, seaweed fiber, and any combinations thereof. In some embodiments, the enhancement of taste or texture includes reducing a green vegetal taste, reducing a sour taste, increasing a sweet taste, reducing a bitter taste, reducing an astringent taste, increasing firmness, reducing a grainy texture, increasing thickness, increasing mouthfeel, or any combination thereof. In certain related aspects, the disclosure provides comestible compositions that include fermented plant milk and a plant fiber or starch.

### DESCRIPTION OF RELATED ART

The human diet generally includes both animal-derived and non-animal-derived products. In recent years, the proportion of calories consumed from animal-derived products has increased. This poses certain health-related concerns, as eating too much dairy, for example, contributes to heart disease and related problems, and may cause certain allergic reactions due to the presence of lactose. Another concern relates to sustainability. Raising and maintaining animals for milk often requires large amounts of grain or grass to use as animal feed. It requires many times more acres of land to grow the grass or grain to feed such animals than it would to grow plants for direct human consumption. Thus, as the global population continues to increase, the demand for increasing agricultural space becomes steadily unsustainable.

Thus, there is increasing demand to replace animal products in the human diet with similar materials derived from plants, algae, fungi, and the like. In many cases, because consumers have become accustomed to consuming animal products, these non-animal-based alternative foods are designed to simulate the flavor, texture, and culinary experience of consuming dairy or meat products. But creating such meat or dairy analogue materials poses a number of challenges, as one attempts to use plant-derived materials to create a food product that simulates eating an analogous animal-derived product.

One such challenge involves simulating the taste and texture of animal-derived products. For example, vegan dairy products often lack the creamy and smooth taste that consumers associate with dairy products. Instead, consumers often perceive certain off tastes and a chalkiness associated with plant proteins and an absence of saturated fats. Further, such dairy analogue products are often less viscous than their dairy counterpart products.

Therefore, there is a continuing need to develop and improve non-animal dairy analogue products that better simulate the taste and texture profile of their dairy counterparts.

### SUMMARY

The present disclosure relates to the discovery that certain plant fibers and starches provide unexpected in the flavor or texture of dairy analogue products, such as fermented dairy analogue products.

In a first aspect, the disclosure provides uses of a plant fiber or a plant starch to improve a flavor or texture of an ingestible composition; wherein the ingestible composition comprises a plant-derived milk, a fermented plant-derived milk, or a fermented animal-derived milk, such as fermented cow milk. In certain related aspects, the disclosure provides methods of improving a flavor or a texture of an ingestible composition, the method comprising introducing a plant fiber or a plant starch to an ingestible composition; wherein the ingestible composition comprises a plant-derived milk or a fermented plant-derived milk. In some embodiments, the use or method is to improve a flavor of an ingestible composition. In some such embodiments, to improve a flavor is one or more of: to reduce a green vegetal taste, to reduce a sour taste, to increase a sweet taste, to reduce a bitter taste, to reduce an astringent taste, or to enhance a mouthfeel. In some embodiments, the use or method is to improve a texture of an ingestible composition. In some such embodiments, to improve a texture is one or more of: to increase firmness, to increase thickness, or to reduce a grainy texture. In some embodiments, the ingestible composition comprises a fermented plant-based milk, such as a fermented nut milk, a fermented soy milk, a fermented oat milk, and the like. In some such embodiments, the fermented plant-based milk comprises a plant protein. In some embodiments, the use is use of a plant fiber. In some embodiments, the use is use of a plant starch. In some embodiments, the method comprises introducing a plant fiber. In some embodiments, the method comprises introducing a plant starch. In some embodiments, the plant fiber is a combination of pectin and pea fiber.

In a second aspect, the disclosure provides an ingestible composition, which comprises: (a) a plant-derived milk, a fermented plant-derived milk, or a fermented animal-derived milk, such as fermented cow milk; and (b) a plant fiber or a plant starch. In some embodiments, the ingestible composition comprises a plant fiber. In some embodiments, the ingestible composition comprises a plant starch. In some embodiments, the ingestible composition comprises a fermented plant-based milk, such as a fermented nut milk, a fermented soy milk, a fermented oat milk, and the like. In some such embodiments, the fermented plant-based milk comprises a plant protein.

In a third aspect, the disclosure provides a flavored product comprising an ingestible composition of the second aspect. In some embodiments, the flavored product is a beverage product, such as a dairy or dairy analogue product. In some other embodiments, the flavored product is a food product, such as yogurt analogue product, a meat analogue product, or a seafood analogue product. In some embodiments, the flavored product is an animal feed product, such as a cat feed or dog feed product. In some embodiments, the flavored product is a fermented dairy product.

Further aspects, and embodiments thereof, are set forth below in the Detailed Description, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, “sweetener,” “sweet flavoring agent,” “sweet flavor entity,” or “sweet compound” all refer to a compound or a comestibly acceptable salt thereof that elicits a detectable sweet flavor in a subject, such as a compound that activates a human T1R2 or T1R3 receptor in the course of in vitro screening or that is reported to be sweet via sensory evaluation by human subjects.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

Other terms are defined in other portions of this description, even though not included in this subsection.

### Uses and Methods for Improvement in Flavor or Texture

In at least one aspect, the disclosure provides use of a plant fiber or a plant starch to improve a flavor or a texture of an ingestible composition, wherein the ingestible composition comprises a plant-derived milk, a fermented plant-derived milk, or a fermented dairy milk. In certain related aspects, the disclosure provides a method of improving a flavor or a texture of an ingestible composition, the method comprising introducing a plant fiber or a plant starch to an ingestible composition, wherein the ingestible composition comprises a plant-derived milk or a fermented plant-derived milk. In some embodiments, the ingestible composition comprises a fermented plant-derived milk. In some embodiments, the ingestible composition comprises a fermented dairy milk, such as fermented cow milk.

In some embodiments, the use is a use to improve a flavor of an ingestible composition. In some embodiments, use to improve a flavor is use to reduce a green vegetal taste, use to reduce a sour taste, use to increase a sweet taste, use to reduce a bitter taste, use to reduce an astringent taste, use to enhance a mouthfeel, or any combination thereof. In some embodiments, use to improve a flavor is use to reduce a green vegetal taste. In some embodiments, use to improve a flavor is use to increase a sweet taste. In some embodiments, use to improve a flavor is use to reduce a sour taste. In some embodiments, use to improve a flavor is use to reduce a bitter taste. In some embodiments, use to improve a flavor is use to reduce an astringent taste. In some embodiments, use to improve a flavor is use to enhance a mouthfeel, or any combination thereof.

In some embodiments, the method is a method of improving a flavor of an ingestible composition. In some embodiments, improving a flavor is reducing a green vegetal taste, reducing a sour taste, increasing a sweet taste, reducing a bitter taste, reducing an astringent taste, enhancing a mouthfeel, or any combination thereof. In some embodiments, improving a flavor is reducing a green vegetal taste. In some embodiments, improving a flavor is increasing a sweet taste. In some embodiments, improving a flavor is reducing a sour taste. In some embodiments, improving a flavor is reducing a bitter taste. In some embodiments, improving a flavor is reducing an astringent taste. In some embodiments, improving a flavor is enhancing a mouthfeel.

In some embodiments, the use is a use to improve a texture of an ingestible composition. In some embodiments, use to improve a texture is use to increase firmness, use to increase thickness, use to reduce a grainy texture, or any combinations thereof. In some embodiments, use to improve a texture is use to increase firmness. In some embodiments, use to improve a texture is use to increase thickness. In some embodiments, use to improve a texture is use to reduce a grainy texture.

In some embodiments, the method is a method of improving a texture of an ingestible composition. In some embodiments, improving a texture is increasing firmness, increasing thickness, reducing a grainy texture, or any combination thereof. In some embodiments, improving a texture is increasing firmness. In some embodiments, improving a texture is increasing thickness. In some embodiments, improving a texture is reducing a grainy texture.

### Plant-Based Milks and Fermented Plant-Based Milks

In the various aspects disclosed herein, the ingestible composition comprises a plant-derived milk or a fermented plant-based milk, such as a plant-based yogurt. Such milks or fermented milks can make up any suitable proportion of the ingestible composition. For example, in some embodiments, the plant-derived milk or the fermented plant-derived milk comprise at least 50 weight percent, or at least 60 weight percent, or at least 70 weight percent, or at least 80 weight percent, or at least 90 weight percent, or at least 95 weight percent, or at least 97 weight percent, based on a dry weight of the ingestible composition (meaning that dried solids from the plant-based milk or the fermented plant-derived milk make up such weight percentages of the total dried solids remaining following evaporation to dryness). In some embodiments, the ingestible composition comprises a plant-derived milk. In some embodiments, the ingestible composition comprises a fermented plant-derived milk.

Note that, in this context, the term “fermented” means that the plant-derived milk has undergone a biochemical process in which at least a portion (for example, at least 10 weight percent, or at least 20 weight percent, or at least 30 weight percent, or at least 40 weight percent, or at least 50 weight percent, or at least 60 weight percent, or at least 70 weight percent, based on the total weight of sugars in the plant-based milk) of the sugars in the plant-derived milk are biochemically converted to their corresponding organic acids, analogous to the way in which lactose in cow's milk can be fermented to lactic acid.

The term “plant-derived milk” refers to a milk formed from a plant material. In some embodiments, the milk is a fluid suspension taken directly from the plant. In other embodiments, the milk is a fluid suspension obtained from contacting plant material (including fluid suspensions from the plant) with water. Processes to make various plant-derived milks are well known in the art, and such milks are widely available commercially.

The plant-derived milks can come from any suitable plant source. Non-limiting examples of such plant sourced are soybeans, almonds, hazelnuts, sesame seeds, pistachios, potatoes, bananas, flaxseed, macadamia nuts, cashews, oats, hemp, coconut, and peas. In some embodiments, the fermented plant-derived milk is fermented soy milk. In some embodiments, the fermented plant-derived milk is fermented almond milk. In some embodiments, the fermented plant-derived milk is fermented oat milk. In some embodiments, the fermented plant-derived milk is fermented cashew milk. In some embodiments, the fermented plant-derived milk is fermented hemp milk.

In general, the plant-derived milks and fermented plant-derived milks comprise some amount of plant protein, which occurs naturally in the plant. Thus, the ingestible compositions disclosed herein comprise a plant protein. In some instances, additional protein, such as additional non-animal proteins, can be added. Suitable non-animal proteins include algal proteins, mycoproteins, and plant proteins. Any suitable plant protein can be used. Some non-limiting examples of such plant proteins are pea protein, soy protein, almond protein, cashew protein, canola (rapeseed) protein, chickpea protein, fava bean protein, sunflower protein, mung bean protein, red lentil protein, wheat protein, oat protein, potato protein, and any combinations thereof.

The ingestible composition can include plant proteins at any suitable concentration. In some embodiments, the ingestible composition comprises plant protein at a concentration ranging from 0.1 weight percent to 15 weight percent, or from 0.5 weight percent to 12 weight percent, based on the total weight of the ingestible composition.

The ingestible compositions disclosed herein, including those referenced in various uses and methods, can include any number of other ingredients. Further such embodiments are set forth in greater detail below.

### Plant Fibers and Plant Starches

The uses, methods, and ingestible compositions disclosed herein relate to the use of plant fibers or plant starches to improve flavor or texture.

In some embodiments, the uses, methods or ingestible compositions relate to the use or introduction of a plant fiber. Such fibers include both soluble and insoluble fibers.

As used herein, the term “soluble fiber” refers to polysaccharides characterized as being soluble by using the method of the Association of Official Analytical Chemists (AOAC) and as set forth in Prosky et al., J. ASSOC. OFF. ANAL. CHEM., vol. 70(5), pp. 1017-1023 (1988). Any suitable soluble fibers can be used, including, but not limited to, fruit fiber (such as citrus fiber), grain fibers, psyllium husk fiber, natural soluble fibers and synthetic soluble fibers. Natural fibers include soluble corn fiber, maltodextrin, acacia, and hydrolyzed guar gum. Synthetic soluble fibers include polydextrose, modified food starch, and the like. Non-limiting examples of food-grade sources of soluble fiber include inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose.

In some embodiments, the ingestible composition comprises certain insoluble fibers, which can provide structure and texture to the ingestible composition. Any suitable insoluble fiber can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber.

In some embodiments, the plant fiber is pea fiber, citrus fiber, potato fiber, psyllium fiber, acacia fiber, inulin, konjac fiber, or any combination thereof.

In some embodiments, the plant fiber is pectin, inulin, fruit fiber (such as apple fiber or citrus fiber), oat fiber, pea fiber, seaweed fiber, and any combinations thereof.

In some embodiments, the uses, methods or ingestible compositions relate to the use or introduction of a plant starch. In some such embodiments, the starch is a corn starch.

In some embodiments, the plant fiber is pectin. In some embodiments, the plant fiber is a combination of pectin and pea fiber. In such embodiments, the pectin and the pea fiber can have any suitable weight ratio relative to each other. In some embodiments, the weight ratio of pectin to pea fiber ranges from 1:2 to 20:1, or from 1:1 to 15:1, or from 2:1 to 10:1.

The plant fiber or plant starch can make up, or be introduced, or used in any suitable concentration in the ingestible composition. In some embodiments, the ingestible composition comprises plant fiber or plant starch, or the plant fiber or starch is introduced at a concentration ranging from 0.01 weight percent to 15 weight percent, or from 0.05 weight percent to 12 weight percent, or from 0.1 weight percent to 10 weight percent, or from 0.1 weight percent to 5.0 weight percent, or from 0.1 weight percent to 3.0 weight percent, or from 0.1 weight percent to 1.0 weight percent, or from 0.1 weight percent to 0.8 weight percent, based on the total weight of the ingestible composition.

### Ingestible Compositions

Various aspects, and embodiments thereof, disclosed herein refer to ingestible compositions. In some cases, the ingestible compositions include the plant fiber or plant starch compositions, and, in other cases, the plant fiber or plant starch is introduced to the ingestible composition. As noted above, the ingestible compositions comprise certain non-animal proteins, as described above.

The ingestible composition can include a number of other ingredients. These additional ingredients can be part of the ingestible composition.

### Flavorings, Extracts, and Flavor and Aroma Modifiers

The ingestible composition, or the protein supplement composition, include, in some embodiments, one or more flavorings, extracts, flavor modifiers, aroma modifiers, or any combination thereof.

The comestible compositions disclosed herein comprise a flavoring. In general, the flavoring improves the taste and flavor of the ingestible composition or the resulting flavored product in which the ingestible composition is used. Such improvement includes reducing the bitterness of the ingestible composition or the resulting flavored product, reducing the perception of astringency of the ingestible composition or the resulting flavored product, reducing the perception of green taste notes (such as pea taste) of the ingestible composition or the resulting flavored product, reducing the perception of cereal notes of the ingestible composition or the resulting flavored product, improving the perception of creaminess of the ingestible composition or the resulting flavored product, improving the perception of fattiness of the ingestible composition or the resulting flavored product, improving the perception of sweetness of the ingestible composition or the resulting flavored product, improving the perception of savory taste (umami or kokumi) of the ingestible composition or the resulting flavored product, improving the mouthfeel or mouthcoating of the ingestible composition or the resulting flavored product, improving the perception of juiciness of the ingestible composition or the resulting flavored product, improving the perception of thickness of the ingestible composition or the resulting flavored product.

Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish crème, white chocolate, raspberry, pumpkin pie spice, peppermint, or any combination thereof. In some embodiments, the ingestible composition comprises a vanilla or creamy flavoring.

In some embodiments, the flavoring is a flavoring that provides a meat or savory tonality, including flavorings or tonalities of beef, lamb, bison, smoke, pork, bacon, ham, sausage, chicken, turkey, goose, duck, mushroom, celery, tomato, onion, garlic, carrot, leek, fish, shellfish, soy, miso, and the like. In some further embodiments, the flavoring comprises one or more lactones, which impart a creamy flavor to the ingestible composition.

In some embodiments, the flavoring comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80°° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

The flavoring also includes, in certain embodiments, one or more additional flavor-modifying compounds, such as compounds that enhance sweetness (e.g., phloretin, naringenin, glucosylated steviol glycosides, etc.), compounds that block bitterness, compounds that enhance umami, compounds that enhance kokumi, compounds that reduce sourness or licorice taste, compounds that enhance saltiness, compounds that enhance a cooling effect, compounds that enhance mouthfeel, or any combinations of the foregoing.

In some embodiments, the ingestible composition comprises a sweetener. The sweetener can be present in any suitable concentration, depending on factors such as the sweetener's potency as a sweetener, its solubility, and the like. In some embodiments, the ingestible composition comprises steviol glycosides, such as glucosylates steviol glycosides, and a yeast lysate.

In general, the ingestible compositions disclosed herein can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the additional sweetener is a combination of two or more of the sweeteners set forth in this paragraph. In some embodiments, the sweetener may combinations of two, three, four or five sweeteners as disclosed herein. In some embodiments, the additional sweetener is a sugar. In some embodiments, the additional sweetener is a combination of one or more sugars and other natural and artificial sweeteners. In some embodiments, the additional sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar is sucrose. In some embodiments, the sugar is a combination of fructose and glucose.

In some embodiments, the sweeteners can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

In some embodiments, the flavoring comprises one or more sweetness enhancing compounds. Such sweetness enhancing compounds include, but are not limited to, naturally derived compounds, such as hesperitin dihydrochalcone, hesperitin dihydrochalcone-4′-O′glucoside, neohesperitin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, eriodictyol, homoeriodictyol, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide or N-(1-((4-amino-2,2-dioxo-1H-benzo[c][1,2,6]thiadiazin-5-yl)oxy)-2-methyl-propan-2-yl) isonicotinamide.

In some further embodiments, the flavoring comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl) decane-3,5-diol diacetate. In some embodiments, the umami-enhancing compound is N-(heptan-4-yl)benzo[d][1,3]dioxole-5-carboxamide.

In some embodiments, the ingestible composition comprises one or more compounds commonly used in savory products. Such flavorings include glutamates (such as MSG), arginates, avocadene, avocadyne, a purine ribonucleitide (such as inosine monophosphate (IMP), guanosine monophosphate (GMP), hypoxanthine, inosine), a yeast extract (as noted above), a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, or any combinations thereof.

In some further embodiments, the flavoring comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavoring comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759, or in PCT Publication No. WO 2020/033669. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavoring comprises one or more sour taste modulating compounds.

In some further embodiments, the flavoring comprises one or more mouthfeel modifying or mouthfeel enhancing compounds. Such mouthfeel modifying compounds include, but are not limited to, polymethoxylated flavones, tannins, cellulosic materials, bamboo powder, and the like.

In some further embodiments, the flavoring comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the comestible composition itself, or that may be included within the flavored products that employ such compositions. Such tastants include sweeteners, umami tastants, kokumi tastants, bitter tastants, sour tastants, and the like.

In some embodiments, the ingestible comprises one or more metal salts or metal complexes, such as iron salts or iron complexes. Such compounds can include any comestible metal salt or complex, such as salts or complexes of calcium, magnesium, sodium, potassium, iron, cobalt, copper, zinc, manganese, molybdenum, and selenium. In some embodiments, the iron compound is an iron salt or an iron complex. In some particular embodiments, the metal compound is a ferrous (Fe²⁺) salt or a ferrous (Fe²⁺) complex. In some embodiments, the metal compound is a ferrous (Fe²⁺) salt, such as ferrous sulfate, ferrous lactate, ferrous fumarate, ferrous gluconate, ferrous succinate, ferrous chloride, ferrous oxalate, ferrous nitrate, ferrous citrate, ferrous ascorbate, ferric citrate, ferric phosphate, or any combination thereof. In some other embodiments, the metal compound is a ferric (Fe³⁺) salt or a ferric (Fe³⁺) complex, such as ferric pyrophosphate. In some embodiments, the iron compound is ferrous lactate, ferrous sulfate, or any combination thereof.

In some embodiments, the iron compound is a heme-containing protein. As used herein, the term “heme containing protein” includes any polypeptide covalently or noncovalently bound to a heme moiety. In some embodiments, the heme-containing polypeptide is a globin and can include a globin fold, which comprises a series of seven to nine alpha helices. Globin type proteins can be of any class (for example, class I, class II, or class III), and in some embodiments, can transport or store oxygen. For example, a heme-containing protein can be a non-symbiotic type of hemoglobin or a leghemoglobin. A heme-containing polypeptide can be a monomer, such as a single polypeptide chain, or can be a dimer, a trimer, tetramer, and/or higher order oligomer. The lifetime of the oxygenated Fe²⁺ state of a heme-containing protein can be similar to that of myoglobin or can exceed it by 10%, or 20%, or 30% >, or 40%, or 50%, or even 100%. or more under conditions in which the heme-protein-containing consumable is manufactured, stored, handled or prepared for consumption.

Non-limiting examples of heme-containing proteins include an androglobin, a cytoglobin, a globin E, a globin X, a globin Y, a hemoglobin, a myoglobin, an erythrocruorin, a beta hemoglobin, an alpha hemoglobin, a protoglobin, a cyanoglobin, a cytoglobin, a histoglobin, a neuroglobins, a chlorocruorin, a truncated hemoglobin (e.g., HbN or HbO), a truncated 2/2 globin, a hemoglobin 3 (e.g., Glb3), a cytochrome, or a peroxidase.

Heme-containing proteins that can be used in the comestible compositions described herein and can be from mammals (for example, farm animals such as cows, goats, sheep, pigs, ox, or rabbits), birds, plants, algae, fungi (for example, yeast or filamentous fungi), ciliates, or bacteria. For example, a heme-containing protein can be from a mammal such as a farm animal (e.g., a cow, goat, sheep, pig, fish, ox, or rabbit) or a bird such as a turkey or chicken. Heme-containing proteins can be from a plant such as Nicotiana tabacum or Nicotiana sylvestris (tobacco); Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (mung beans), Lupinus albus (lupin), or Medicago sativa (alfalfa); Brassica napus (canola), Triticum sps. (wheat, including wheat berries, and spelt); Gossypium hirsutum (cotton); Oryza sativa (rice); Zizania sps. (wild rice); Helianthus annuus (sunflower); Beta vulgaris (sugarbeet); Pennisetum glaucum (pearl millet); Chenopodium sp. (quinoa); Sesamum sp. (sesame); Linum usitatissimum (flax); or Hordeum vulgare (barley). Heme-containing proteins can be isolated from fungi such as Saccharomyces cerevisiae, Pichia pastoris, Magnaporthe oryzae, Fusarium graminearum, Aspergillus oryzae, Trichoderma reesei, Myceliopthera thermophile, Kluyveramyces lactis, or Fusarium oxysporum. Heme-containing proteins can be isolated from bacteria such as Escherichia coli, Bacillus subtilis, Bacillus licheniformis, Bacillus megaterium, Synechocistis sp., Aquifex aeolicus, Methylacidiphilum infernorum, or thermophilic bacteria such as Thermophilus spp. The sequences and structure of numerous heme-containing proteins are known. See, for example, Reedy, et al, Nucleic Acids Research, 2008, Vol. 36, Database issue D307-D313 and the Heme Protein Database available on the world wide web at http://hemeprotein.info/heme.php.

In some embodiments, a non-symbiotic hemoglobin can be from any plant. In some embodiments, a non-symbiotic hemoglobin can be from a plant selected from the group consisting of soybean, sprouted soybean, alfalfa, golden flax, black bean, black eyed pea, northern bean, tobacco, pea, garbanzo, moong bean, cowpeas, pinto beans, pod peas, quinoa, sesame, sunflower, wheat berries, spelt, barley, wild rice, and rice.

In some embodiments, the heme-containing protein is a leghemoglobin, such as a soy, pea, or cowpea leghemoglobin.

Heme-containing or other proteins also can be recombinantly produced using polypeptide expression techniques (e.g., heterologous expression techniques using bacterial cells, insect cells, fungal cells such as yeast, plant cells such as tobacco, soybean, or Arabidopsis, or mammalian cells). For example, leghemoglobin can be recombinantly produced in E. coli or Pichia pastoris. In some cases, standard polypeptide synthesis techniques (such as liquid-phase polypeptide synthesis techniques or solid-phase polypeptide synthesis techniques) can be used to produce heme-containing proteins synthetically. In some cases, in vitro transcription-translation techniques can be used to produce heme-containing proteins.

The heme-containing proteins or iron salts can be used at any suitable concentration. Examples are set forth in PCT Publication No. WO 2015/153666, which is incorporated herein by reference.

The iron compound can make up any suitable weight of the ingestible particle. In some embodiments, the iron compound makes up from 0.1 percent by weight to 10 percent by weight, or from 0.2 percent by weight to 5 percent by weight, or from 0.5 percent by weight to 3 percent by weight, of the ingestible composition, based on the total dry weight of the ingestible composition.

### Other Additives

Various other additives can be included in the ingestible or can be introduced to the ingestible composition as part of the protein additive composition.

For example, in some embodiments, the ingestible composition comprises an emulsifier. Any suitable emulsifier can be used. For example, in some non-limiting embodiments, the emulsifier comprises lecithin, monoglycerides, diglycerides, polysorbates, vegetable oils, and the like. In some embodiments, the emulsifier comprises lecithin. Other examples of emulsifiers can be found in McCutcheon's Emulsifiers & Detergents or the Industrial Surfactants Handbook. The emulsifier can be present in any suitable concentration, which can be adjusted so as to form a stable emulsion of the other components in the comestible composition, for example, when incorporated into a flavored product.

In some instances, it may be desirable to include additives that assist in adjusting the viscosity of the ingestible composition (for example, when the ingestible composition is introduced into water or includes water). Various salts and acids can be used to carry out such adjustments. In some embodiments, the comestible composition or the resulting flavored product comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the comestible composition or the resulting flavored product also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid or mixtures thereof.

The ingestible compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
propylene glycol, ethyl alcohol, glycerine, gum Arabic (gum acacia), modified corn starch, silicon dioxide, magnesium carbonate, or tricalcium phosphate; or
starches and stabilizers, including, for example, polysorbate 60, polysorbate 80, medium chain triglycerides, and the like.

In some embodiments, component (a) can further comprise galact-oligosaccharides, fructo-oligosaccharides, acacia fiber, soluble pea fiber, soluble wheat fiber, arabinoxylan, isomalto-oligosaccharides, xylo-oligosaccharides, and the like.

The comestible composition can contain any of a number of ingredients, such as ingredients typically included in meat analogue products.

For example, in some embodiments, the comestible composition comprises a flavored water-in-oil emulsion according to any of the embodiments set forth in PCT Publication No. WO 2020/260628, which is hereby incorporated by reference.

In some embodiments, the comestible composition comprises encapsulated flavor compositions according to any of the embodiments set forth in PCT Publication No. WO 2021/104846, which is hereby incorporated by reference.

In some embodiments, the ingestible composition further comprises a carrier and, optionally, at least one adjuvant. The term “carrier” denotes a usually inactive accessory substance, such as solvents, binders, bulking agents, or other inert medium, which is used in combination with the present compound and one or more optional adjuvants to form the formulation. For example, water or starch can be a carrier for a flavored product. In some embodiments, the carrier is the same as the diluting medium for reconstituting the flavored product; and in other embodiments, the carrier is different from the diluting medium. The term “carrier” as used herein includes, but is not limited to, comestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

The ingestible composition may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavored product. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavored product can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In some embodiments, the ingestible composition is formulated to have a low water activity for extended shelf life. Water activity is the ratio of the vapor pressure of water in a formulation to the vapor pressure of pure water at the same temperature. In one embodiment, the ingestible composition has a water activity of less than about 0.85. In another embodiment, the ingestible composition has a water activity of less than about 0.80. In another embodiment, the ingestible composition has a water activity of less than about 0.75.

### Methods of Preparation

The ingestible compositions disclosed herein can be made by any suitable means, as typically employed in the manufacturing of plant-derived milks and fermented plant-derived milks.

### Flavored Products

In certain aspects, the disclosure provides a flavored product, which comprises the ingestible composition according to any of the embodiments set forth above. In some embodiments, the flavored product is a food product, such as a dairy analogue product, for example, a non-animal-based yogurt. In other embodiments, the flavored products contains no animal-based products, such that the ingestible composition is used to make an analogue or a replica of a dairy product, such as a vegan yogurt.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described and claimed herein. The reader will recognize that the skilled artisan, armed with the present disclosure, and skill in the art is able to prepare and use the invention without exhaustive examples.

### Example 1

### Soy Yogurt with Fiber or Starch Added

Soy yogurt was prepared from soy milk by introducing lactic acid bacteria to the soy milk. The yogurt was refrigerated overnight. Nine samples were prepared: two controls (Control 1 and Control 2) and seven containing 1.5 weight percent of a plant fiber or starch. The seven fibers or starches used are: inulin, a high-pectin citrus fiber (Citrus HP in Table 1), oat fiber, pea fiber, a high-water-holding citrus fiber (Citrus HW in Table 1), corn starch, and pectin. The samples were allowed to reach room temperature. Approximately 25 sensory panelists evaluated each sample on twelve different criteria: green vegetal note (GV), raw cereal note (RC), toasted cereal note (TC), citrus note (CT), sourness (SO), sweetness (SW), bitterness (BT), astringency (AS), firmness (FM), grainy texture (GT), thickness (TK), and mouthcoating (MC). The panelists evaluated each sample on a scale from 0 to 5, with higher scores indicating greater intensity of the criterion. Table 1 reports the mean score of the panelists for each sample with respect to the twelve criteria.

TABLE 1

| | GV | RC | TC | CT | SO | SW | BT | AS | FM | GT | TK | MC |
|---|---|---|---|---|---|---|---|---|---|---|---|---|
| Citrus HP | 3.5 | 2.7 | 1.7 | 1.7 | 2.3 | 0.8 | 2.1 | 3.6 | 4.4 | 3.8 | 6.1 | 3.5 |
| Control 1 | 4.0 | 3.0 | 0.7 | 2.2 | 3.9 | 0.9 | 2.7 | 4.0 | 2.2 | 4.4 | 3.6 | 2.5 |
| Oat | 2.3 | 3.0 | 1.0 | 2.6 | 4.3 | 0.5 | 2.5 | 3.5 | 2.3 | 5.3 | 3.5 | 3.0 |
| Pea | 3.2 | 3.0 | 1.1 | 1.4 | 3.4 | 0.4 | 2.1 | 3.2 | 3.5 | 6.6 | 4.2 | 2.9 |
| Control 2 | 3.6 | 2.2 | 1.2 | 2.9 | 3.9 | 0.6 | 2.0 | 2.8 | 1.8 | 2.9 | 2.8 | 2.4 |
| Citrus HW | 2.4 | 2.4 | 0.8 | 1.7 | 2.5 | 0.4 | 1.5 | 2.3 | 5.5 | 3.6 | 6.6 | 3.7 |
| Corn Starch | 2.1 | 2.1 | 1.1 | 1.9 | 1.6 | 0.5 | 1.1 | 1.4 | 4.6 | 5.9 | 5.3 | 3.0 |
| Inulin | 2.7 | 1.9 | 1.2 | 1.6 | 2.2 | 0.9 | 1.7 | 2.6 | 2.2 | 3.7 | 2.5 | 2.2 |
| Pectin | 2.3 | 1.8 | 1.0 | 2.0 | 2.7 | 0.5 | 1.2 | 2.5 | 2.4 | 3.7 | 2.3 | 2.3 |

### Example 2

### Flavored Fiber Blend for Fermented Plant-Based Milk or Dairy Milk

Table 2 shows two fiber blends for plant-based fermented milk (such as a soy or pea yogurt) or fermented dairy milk (such as a dairy yogurt). Amounts shown are the percent 5 weight of each ingredient. based on the total weight of the flavored fiber blend.

TABLE 2

| Ingredient | Sample 2A | Sample 2B |
|---|---|---|
| Pea Fiber | 12 | 12 |
| Pectin | 40 | 40 |
| Maltodextrin | 8 | 8 |
| Flavoring A | 40 | |
| Flavoring B | | 40 |

Flavoring A is a blend of glucosylated steviol glycoside, yeast lysate, and cream flavoring.
Flavoring B is a blend of glucosylated steviol glycoside and yeast lysate.

### Example 3

### Flavored Fiber Blend for Fermented Plant-Based Milk or Dairy Milk

Table 3 shows two fiber blends for plant-based fermented milk (such as a soy or pea yogurt) or fermented dairy milk (such as a dairy yogurt). Amounts shown are the percent weight of each ingredient, based on the total weight of the flavored fiber blend.

TABLE 3

| Ingredient | Sample 3A | Sample 3B |
|---|---|---|
| Pea Fiber | 5 | 5 |
| Pectin | 40 | 40 |
| Maltodextrin | 5 | 5 |
| Flavoring A | 30 | |
| Flavoring B | | 30 |
| Mouthfeel Enhancer | | 20 |
| Mouthfeel Enhancer + | 20 | |
| Cream Flavoring | | |

Flavoring A is a blend of glucosylated steviol glycoside, yeast lysate, and cream flavoring.
Flavoring B is a blend of glucosylated steviol glycoside and yeast lysate.

1. Use of a plant fiber or a plant starch to improve a flavor or a texture of an ingestible composition, wherein the ingestible composition comprises a fermented plant-derived milk or a fermented dairy milk.

2. The use of claim 1, wherein the use is a use to improve the flavor of the ingestible composition.

3. The use of claim 2, wherein the use to improve the flavor of the ingestible composition is one or more of: a use to reduce a green vegetal taste of the ingestible composition, a use to reduce a sour taste of the ingestible composition, a use to increase a sweet taste of the ingestible composition, a use to reduce a bitter taste of the ingestible composition, a use to reduce an astringent taste of the ingestible composition, or a use to to enhance a mouthcoating of the ingestible composition.

4. The use of claim 1, wherein the use is a use to improve the texture of the ingestible composition.

5. The use of claim 4, wherein the use to improve the texture of the ingestible composition is one or more of: a use to increase firmness of the ingestible composition, a use to increase thickness of the ingestible composition, or a use to reduce a grainy texture of the ingestible composition.

6. The use of any one of claims 1 to 5, wherein the ingestible composition comprises a fermented plant-derived milk.

7. The use of claim 6, wherein the fermented plant-based milk is a fermented soy milk, a fermented oat milk, a fermented almond milk, a fermented cashew milk, a fermented coconut milk, a fermented hemp milk, or any combinations thereof.

8. The use of any one of claims 1 to 7, wherein the fermented plant-based milk comprises a plant protein.

9. The use of any one of claims 1 to 8, wherein the use is the use of the plant fiber, such as a combination of pectin and pea fiber.

10. An ingestible composition, which comprises: (a) a fermented plant-derived milk; and (b) a plant fiber or a plant starch.

11. The ingestible composition of claim 10, wherein the ingestible composition comprises a fermented plant-derived milk.

12. The ingestible composition of claim 10 or 11, wherein the ingestible composition comprises a plant fiber, such as a combination of pectin and pea fiber.

13. The ingestible composition of any one of claims 10 to 12, wherein the fermented plant-based milk is a fermented soy milk, a fermented oat milk, a fermented almond milk, a fermented cashew milk, a fermented coconut milk, a fermented hemp milk, or any combinations thereof.

14. The ingestible composition of any one of claims 10 to 13, further comprising steviol glycosides, a yeast lysate, and, optionally, a cream flavoring.

15. A flavored product, which comprises the ingestible composition of any one of claims 10 to 14.
